(19) United States
(12) Patent Application Publication
(10) Pub. No.: US 2015/0305841 A1
(43) Pub. Date: Oct. 29, 2015

(54) DENTAL FLOSSING TOOL

(71) Applicant: JERRELL PENN HOLLAWAY, Melbourne, FL (US)

(72) Inventor: JERRELL PENN HOLLAWAY, Melbourne, FL (US)

(21) Appl. No.: 14/259,751

(22) Filed: Apr. 23, 2014

(51) Int. Cl. A61C 15/04

(52) U.S. Cl. CPC A61C 15/045

(57) ABSTRACT

A dental tool which combines a rubber tip gum massager with a floss threader that aids in positioning floss under fixed bridges. The tool is especially useful in cleaning under bridge work that is in the back of the mouth. It is common practice to employ floss with a few inches of rigid line attached to the actual floss material so that the rigid line can be pushed under the bridge work with the fingers and then pulled through to position the actual flossing material for the back and forth cleaning process. Even with the rigid line threader, however, the process is sometimes difficult for a dental professional and almost impossible for an individual because it is hard to feel when the threader is in the right position. A common rubber tip gum messenger on a handle can easily find the right spot for the threader because of the tactical feed back as the rubber tip is passed over the teeth and gums. The present invention uses a hole that passes through the handle of the rubber tip tool and on through the end of the rubber tip itself. The rigid floss threader line is inserted into the hole in the handle and pushed all the way to the end of the rubber tip, ready to be advanced under the bridge as soon as the rubber tip feels the right spot. An important feature of the tool is that the hole in the handle is positioned opposite of the direction of the rubber tip, so that the hand holding the handle is on the other side of the teeth from the hand pushing the threader.

### BACKGROUND OF THE INVENTION

1. Field of the Invention

The present invention relates to dental aids and more specifically to tools and apparatus used in flossing teeth.

2. Discussion of Related Art

To date, the main aids to flossing under bridge work are special floss strands that are attached to short sections of rigid line. The rigid line is intended to be pushed under the bridge and pulled through from the other side of the bridge. These products are called floss threaders.

Another aid is a section of rigid line that has a loop on one end of the line. This product works by placing a section of standard floss material through the loop and then inserting the other end of the line under the bridge. In this case the loop with the folded floss material is pulled through under the bridge and then used in the normal back and forth manner.

### SUMMARY OF THE INVENTION

The present invention overcomes the short comings of the related art by using a rigid handle to position the dental floss threader to the exact spot necessary to feed the between teeth and under bridge work. The exact spot is easily found because the threader line passes through a hole in the end of a rubber tip, as well known in the dental profession as a gum massager. This shape that comes to a point is used to feel and locate positions around the teeth and gums. The rubber tip can also be used to depress swollen gums while advancing the floss threader under the bridge. The threader is inserted into a hole in the handle of the gum massager and advanced on through the hole to the hole in the rubber tip of the massager, where it is then pushed under the bridge, allowing the actual floss material to be pulled under the bridge. The hole in the handle where the threader is inserted is opposite the direction of the threader coming out of the rubber tip. The threader is actually turned 180 degrees from the direction it was inserted. This results in having the tool on one side of the bridge and the fingers pushing the threader on the other side of the bridge. This is much better than having two hands on the same side.

### BRIEF DESCRIPTION OF THE DRAWINGS

FIG. 1 shows the handle, the rubber tip, the hole through the handle and tip, and the floss threader through the hole.

### DETAILED DESCRIPTION OF THE PREFERRED EMBODIMENTS

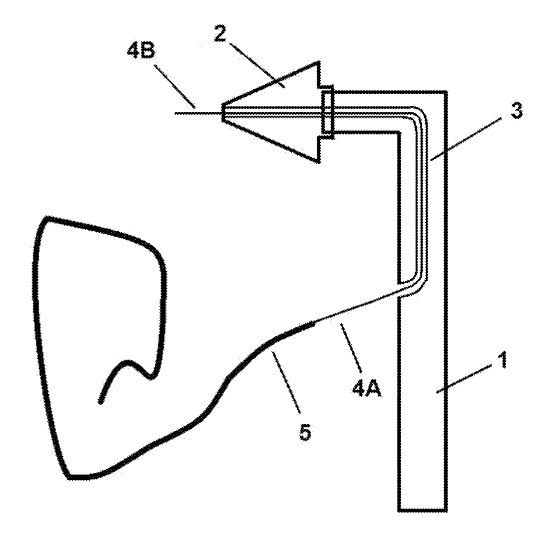

Referring to FIG. 1, rubber tip 2 is attached to handle 1. Hole 3 passes through both the handle and the tip to create a holding means for positioning the rigid dental floss threader near on end of the handle. Floss threader 4A is shown entering hole 3 in handle 1 and exiting rubber tip 2 as threader extension 48. The actual floss material 5 is shown attached to floss threader 4A.

In actual use, one hand holds handle 1 and positions rubber tip 2 in a position under the bridge work while the other hand holds floss threader 4A and gently pushes the threader until the other end of 4B exits rubber tip 2 and passes under the bridge. At that point the hand that was pushing 4A reaches into the mouth and pulls 4B until floss material 5 is in place under the bridge and ready for flossing.

The steps for using threaders with a loop on the end is the same except that the floss material must be placed in the loop of the threader before the loop is pulled through hole 3.

Rubber tip 2 may be replaced with a similar shape that is pointed but molded or milled as part of handle 1.

It is expected that rubber tip 2 be molded with an insert to create the required hole. Likewise, if handle 1 is a molded piece, an insert can created the hole.

If handle 1 is made from metal, such as aluminum, the necessary hole can be drilled in a straight section of the metal. Afterwards handle 1 can be formed into a curved shape to create an offset angle from the rest of the handle on the end that is to attached with the rubber tip.

Another method of manufacture is to start with a metal tube that has the desired length, diameter, and hole size and bend it into the desired shape.

Other improvements maybe made to the present invention without departing from the spirit of what is taught herein.

1. A dental tool for positioning dental floss under bridge work comprising:
a. A single rigid handle with one end of said handle having an offset angle from rest of said handle to allow positioning of a floss threader under said bridge work.
b. the end of said handle with said offset also having a shape that comes to a point where said point is used for feeling and locating positions under said bridge work,
c. a hole in said point of said shape suitable for holding said dental floss threader and for advancing a section of attached dental floss through said hole.
d. a portion of said handle also suitable for holding said threader and said floss and connecting with said hole in said point of said shape.
e. a hole in outer wall of said handle connecting to said portion of said handle suitable suitable for hold said threader and said floss, wherein said hole is positioned to allow said threader and said floss to be advanced by hand through said portion of said handle until said threader and said floss exit said tool through said point.

2. The tool in claim 1, wherein said shape is created by attaching a conically shaped rubber tip to said one end of said handle.

3. The tool in claim 2, wherein said rubber tip has a hole that connects with said hole in said portion of said handle.

4. The tool in claim 2, wherein said rubber tip has a hole that connects with said hole in said portion of said handle.

5. The tool in claim 1, wherein said advancing means is a portion of said threader line that can be pushed by fingers through a hole in said handle causing the other end of said threader line to pass through a hole near said point in said shape.

6. The tool in claim 5, wherein said hole in said handle is approximately 180 degrees from the direction of said threader line that passes through said hole near said point.

7. A method for using dental floss under bridge work comprising the steps of:
(a) Placing a dental floss threader inside a handle having a hollow space inside said handle suitable for holding said threader;
(b) Passing said threader through a hole in a shape near one end of said handle;
(c) Using said shape to feel gum area around said bridge work until a suitable passageway under said bridge work is found;
(d) advancing said threader through said passageway by pushing the other end of said threader with the hand not holding said handle;
(e) using said hand to further advance [symbol]
